(19) United States
(12) Patent Application Publication
(10) Pub. No.: US 2003/0078152 A1
(43) Pub. Date: Apr. 24, 2003

(54) Free jet centrifuge with monitoring means and method for monitoring the same

(75) Inventors: Helmuth Fischer, Remseck (DE); Hans-Joachim Esch, Heimsheim (DE); Peter Frehland, Muenchen (DE)

Correspondence Address: CROWELL & MORING LLP, INTELLECTUAL PROPERTY GROUP, P.O. BOX 14300, WASHINGTON, DC, 20044-4300, US

(73) Assignee: Filterwerk Mann & Hummel GmbH, Ludwigsburg (DE)

(21) Appl. No.: 10/264,250

(22) Filed: Oct. 4, 2002

Related U.S. Application Data
(63) Continuation of application No. PCT/EP01/03293, filed on Mar. 22, 2001.

(30) Foreign Application Priority Data
Apr. 5, 2000 (DE) 100 16 876.0

(51) Int. Cl. B04B 9/06; B04B 13/00

(52) U.S. Cl. 494/10; 494/49

(57) ABSTRACT

A method of monitoring the operation of a free jet centrifuge installed in a fluid system, and a free jet centrifuge suitable for installation in such a system. The centrifuge (10) is provided with sensors, such as a piezoelectric sensor (22) and/or a rotational speed sensor (24), which enable determination of the operating parameters of the centrifuge rotor, such as accumulation of separated sediments, bearing wear, or other malfunctions independent of any axial force generated by the centrifuge nozzles (18). Signals are obtained, which can be evaluated by an electronic analysis system (23), and which can output an error signal (f).

### CROSS REFERENCE TO RELATED APPLICATONS

This application is a continuation of international patent application no. PCT/EP01/03293, filed Mar. 22, 2001, designating the United States of America, and published in German as WO 01/76760, the entire disclosure of which is incorporated herein by reference. Priority is claimed based on Federal Republic of Germany patent application no. DE 100 16 876.0, filed Apr. 5, 2000.

### BACKGROUND OF THE INVENTION

The present invention relates to a method for monitoring a system comprising a free jet centrifuge and to free jet centrifuges with monitoring improved monitoring capabilities.

Free jet centrifuges with monitoring devices are known, for example, from DE 44 03 425 A1. The aim of such monitoring devices is to be able to detect any malfunctioning of the centrifuge or to determine the degree of filling produced by the separation process in order to obtain information on the point in time when the centrifuge rotor must be replaced (column 3, lines 12 to 22 of the cited document). To achieve the stated aim in a simple manner, FIG. 1 of the document shows a centrifuge rotor, which is supported on a shaft and which has axial play. The nozzles 48 are directed obliquely downward, such that operation of the centrifuge creates an axial force component that urges the rotor against its weight against a contact ring mounted on the upper axial limit stop for the rotor. A malfunction is displayed if the rotor leaves the contact ring during operation.

A monitoring device with such a structural configuration, however, cannot determine with certainty the reason why the rotor leaves the contact ring. Causes may include, for instance, an increase in the weight of the centrifuge due to the filter cake that is being accumulated, clogging of the nozzles, or even stiffness of the sleeve bearings 30, 28 being used. In addition, an axial force caused by the oil pressure, which results from the fluid to be centrifuged flowing into the rotor from below and pushing the rotor up along its axis, is superimposed on the axial force component produced by the nozzle position. As a result, if the pressure increase of the fluid is excessive, the rotor may be pressed against the contact ring even if the rotor is not functioning, so that the monitoring device fails to achieve its intended function.

Furthermore, the described monitoring device is unsuitable if the centrifuge rotor is axially fixed in the housing as described in U.S. Pat. No. 6,354,987 (cf. FIG. 2). This type of construction permits the use of ball bearings, which results in low torque resistance of the rotor and reduces the leakage rate along the bearings. However, this type of centrifuge construction must also be monitored depending on the conditions under which it is used.

### SUMMARY OF THE INVENTION

It is an object of the invention to provide an improved method for monitoring the functioning of a free jet centrifuge.

Another object of the invention is to provide a method of monitoring a free jet centrifuge which reliably determines any malfunctioning of the centrifuge.

A further object of the invention is to provide a free jet centrifuge with monitoring means exhibiting improved reliability.

These and other objects have been achieved in accordance with the present invention by providing a method of monitoring a free jet centrifuge comprising a rotor with at least one drive nozzle through which a liquid to be centrifuged is discharged to drive the rotor about an axis of rotation, said method comprising monitoring at least one rotor parameter independently of any axial force produced by discharge of liquid through the at least one drive nozzle and acting in the direction of the axis of rotation.

In accordance with a further aspect of the invention, the objects are achieved by providing a free jet centrifuge comprising a housing, and a rotor having at least one drive nozzle and rotatably supported in said housing; wherein said rotor is axially fixed in at least one direction, and wherein a pressure sensor is provided for measuring axial forces acting on the axially fixed rotor.

In yet another aspect of the invention, the objects are achieved by providing a free jet centrifuge comprising a housing; a rotor rotatably supported in said housing, said rotor having at least one drive nozzle through which a liquid to be centrifuged is discharged to drive the rotor about an axis of rotation, and being axially fixed in at least one direction; and a speed sensor for determining the rotational speed of said rotor.

The method of the invention is suitable for monitoring a system, which at a minimum comprises a free jet centrifuge and a liquid to be centrifuged. The system may also comprise additional components. For instance, the combination of a centrifuge and a liquid filter may also be considered a system, in which case the centrifuge is provided in a bypass flow in order to separate very fine suspended particles. Such applications arise, for instance, in the automotive field for cleaning the lubricating oil of an internal combustion engine.

The method is characterized in that monitoring is possible independent of an axial force that acts on the rotor of the centrifuge along its axis of rotation. This has the advantage that monitoring is independent of the interplay between the components producing the axial force. Any malfunction can thus be determined even without considering the mechanical properties of the centrifuge, such as bearing wear or nozzle wear, and the pressure curve of the liquid to be centrifuged.

In particular, such determination does not depend on the operation of the centrifuge, since the axial force component produced by the nozzles is not necessary. An indication of the degree of filling of the centrifuge and thus its weight can be obtained even when the centrifuge is stopped, so that disturbance variables that could potentially distort the result can be substantially excluded.

The monitoring signal can be forwarded to appropriate output devices, which display the malfunction. In the automotive field, this may comprise, for instance, control lamps on the vehicle dashboard. It is also feasible, however, to evaluate the measuring signals using the engine electronics.

In accordance with one advantageous embodiment of the invention, monitoring is carried out by a pressure sensor that generates a signal as a function of the axial force acting on the rotor. A piezoelectric sensor, in particular, may be used for this purpose. Measuring the axial force in terms of the invention, however, does not depend on the axial force produced by the nozzles. Thus in this case it is again possible to determine, for instance, the axial force even when the centrifuge is stopped, so that the aforementioned advantages are achieved.

Measurements during operation of the centrifuge are of course also possible, in which case an axial force component of the nozzles must be taken into account if the nozzles are placed at an angle. A purely horizontal action of the nozzles is also feasible, however. This has the advantage that the propulsion of the nozzles can be used exclusively to drive the centrifuge, so that higher speeds can be achieved.

Other functional principles for the pressure sensor are of course also feasible, e.g., a pressure piston, where the liquid pressure in the piston is proportional to the axial force on the rotor. To obtain results that are as undistorted as possible during operation of the rotor, the pressure of the fluid to be centrifuged can be determined in addition. This can be accomplished, for instance, by sensors, which are in any case provided in the system, e.g., the internal combustion engine. These values are evaluated in any case by the engine electronics and can be supplemented by the measured values obtained directly at the centrifuge. In addition, other sensors in the system can be used to obtain the most precise information possible regarding the state of the centrifuge.

It is also possible to monitor the state of the centrifuge by using a rotational speed sensor, which may, in particular, be constructed as an optoelectronic sensor. An alternative embodiment of the sensor would be, for instance, a tacho-generator. A speed sensor is used to determine the speed of the rotor. This measurement signal can be evaluated as such in order, for example, to monitor whether the centrifuge reaches its nominal speed. Additional information can be obtained by using additional parameters.

For example, a time measurement can be used to determine the acceleration behavior of the centrifuge. Through the acceleration behavior, the build-up of the filter cake in the rotor can be monitored indirectly, since the increasing inertia of the rotor resulting from accumulated sediment causes an increase in the acceleration time.

If the rotor weight is determined in parallel by some other means, a comparison of the acceleration time and the rotor weight provides additional information regarding any malfunctioning of the centrifuge. For instance, an increase in bearing friction or clogging of the nozzles could be detected because the acceleration time would increase without an increase in weight of the rotor. The pressure of the liquid to be centrifuged can also be evaluated to increase the reliability of the monitoring.

In addition to the acceleration behavior, the time required by the centrifuge to switch between certain characteristic operating states can also be determined. This requires additional sensors that indicate the attainment of or departure from these characteristic operating states. If the free jet centrifuge is used in an internal combustion engine, it is possible, for instance, to use signals regarding the loading condition of the engine, its oil requirement, or the delivery rate of the oil pump in the lubricating oil system.

It is advantageous also to apply the monitoring method to the liquid to be centrifuged itself. One important parameter in the functioning of the centrifuge is the viscosity of this liquid. For instance, the viscosity of the lubricating oil of an internal combustion engine changes as a function of the operating temperature and the age of the lubricating oil. Thus, monitoring the viscosity in such a case can be used to arrive at individual oil change intervals making it possible to lengthen the intervals to an optimal degree. This increases both the economic efficiency in operation and the environmental compatibility of the internal combustion engine.

The viscosity of the liquid, however, can also be considered a criterion for the functioning of the centrifuge. The influence of the viscosity on the acceleration behavior of the centrifuge can thereby be taken into account.

The invention also includes the provision of a free jet centrifuge that is suitable for carrying out the described method. The rotor of the centrifuge is axially fixed in at least one direction. This axial fixation of the rotor can be used for a pressure sensor that measures the axial force of the rotor in the direction of the axial fixation. The resulting measured value can be processed as described above.

In accordance with a further embodiment of the invention, the rotor is supported in the housing without play in axial direction. This produces an axial fixation in both directions so that the pressure sensor can detect axial force components in both directions. This is an advantage, since when the rotor is stopped an axial force acts in downward direction whereas during operation of the rotor, upward axial forces may also occur.

These latter forces are produced by a possible oblique position of the drive nozzles of the rotor in downward direction and by the resulting oil pressure acting along the interior walls of the rotor. Depending on the loading of the rotor by the filter cake, an axial force can also act in downward direction during operation of the rotor.

In contrast to the monitoring device depicted in FIG. 1 of DE 44 03 425 A1, the monitoring system of the present invention can thus determine the functioning of the centrifuge independent of the axial force acting on the rotor.

In particular, it is possible to generate a continuous measuring signal, since this signal does not depend on the axial component produced by the oblique position of the nozzles but must merely take this axial component into account if it occurs. The signal is also continuous with respect to the measured value. Thus, the build-up of the filter cake, for instance, can be monitored, making it possible to draw conclusions e.g., about oil change intervals.

According to a particularly advantageous embodiment of the invention, the centrifuge rotor is supported in the housing by a ball bearing. This ball bearing is capable of absorbing the axial forces of the rotor and of providing them to the pressure sensor. It also reduces friction, so that higher rotational speeds may be achieved by the rotor.

Alternatively, a speed sensor may be mounted on the free jet centrifuge for monitoring purposes. This speed sensor is integrated in the housing at a suitable location. A tacho-generator, for example, would have to be provided on one of the bearings of the rotor to fix it within the housing on the one hand and to connect it with the rotating rotor on the other hand. The measuring signal of the speed sensor can be processed as described above.

These and other features of preferred embodiments of the invention, in addition to being set forth in the claims, are also disclosed in the specification and/or the drawings, and the individual features each may be implemented in embodiments of the invention either alone or in the form of subcombinations of two or more features and can be applied to other fields of use and may constitute advantageous, separately protectable constructions for which protection is also claimed.

### BRIEF DESCRIPTION OF THE DRAWINGS

The invention will be described in further detail hereinafter with reference to illustrative preferred embodiments shown in the accompanying drawings, in which:

FIG. 1 is a schematic cross section of the structure of a free jet centrifuge on which a pressure sensor and a speed sensor are mounted, and

FIG. 2 is a block diagram illustration of a free jet centrifuge arranged in the lubricating oil system of an internal combustion engine.

### DETAILED DESCRIPTION OF PREFERRED EMBODIMENTS

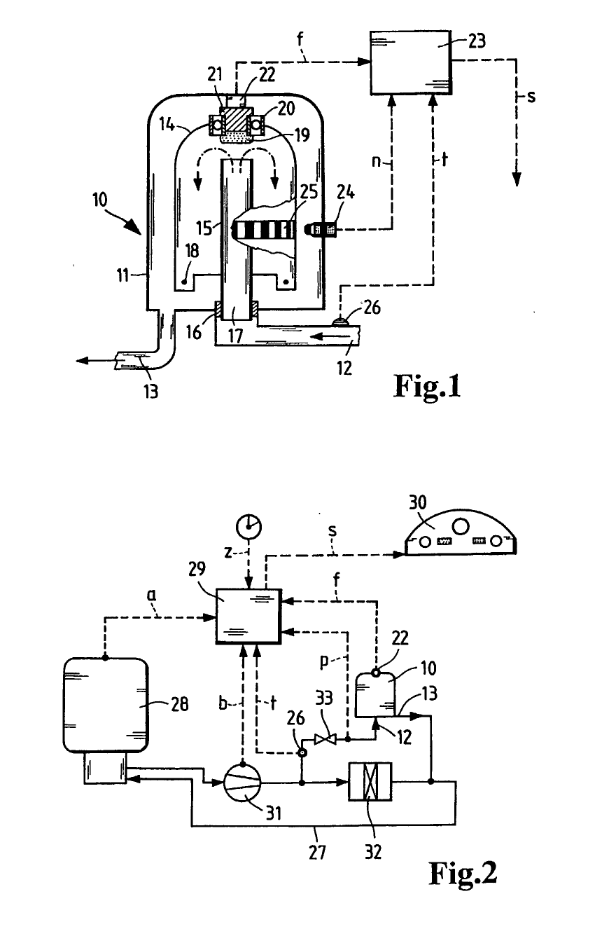

FIG. 1 schematically depicts a free jet centrifuge, as it is used, for instance, for cleaning the lubricating oil of an internal combustion engine. Arrows indicate the flow direction of the liquid oil. The free jet centrifuge 10 has a housing 11, which is equipped with an inlet 12 and an outlet 13. The centrifuge housing does not have to be designed as a free-standing unit. The rotor of the free jet centrifuge can just as well be built into other structures of the internal combustion engine, e.g., the oil pan. A rotor 14 of the centrifuge is supported in a sleeve bearing 16 by a center tube 15. This center tube simultaneously acts as the rotor inlet 17 through which the oil reaches the rotor. Drive nozzles 18 serve as the rotor outlet for the oil. The discharge of oil through the drive nozzles 18 causes the rotor 14 to spin about its axis.

On the exterior of the rotor, a bearing support 19 for a ball bearing 20 is provided. This ball bearing is fixed to the rotor with its outer race. The inner race of ball bearing 20 is provided with a transition piece 21, which is connected with a piezoelectric sensor 22. This sensor is supported in housing 11. The sensor can thereby detect the axial force produced by the rotor and sends the corresponding axial force signal f to an electronic evaluation unit 23.

In addition, an optoelectronic sensor 24 is provided within the housing. This sensor can produce a speed signal n with the aid of a marker 25 on the rotor. This signal, together with a temperature signal t, is processed in the electronic evaluation unit 23. The temperature signal t is provided by a temperature sensor 26 for determining the oil temperature, which is mounted to inlet 12. The electronic evaluation unit outputs a control signal s, which can be used for outputting an error.

FIG. 2 shows the integration of the free jet centrifuge 10 into a lubricating oil system 27 of an internal combustion engine 28. The above-described signals f, t are provided to an engine control unit 29 together with a lubricating oil pressure signal p, a time signal z, and additional engine parameters a, b. These engine parameters can be the speed of the internal combustion engine, the air requirement of the internal combustion engine, the speed or delivery rate of the oil pump of the lubricating oil system, or other parameters. The signals are processed in the engine control unit 29 and are output as control signal s to dashboard 30. A pump 31 that is provided in the lubricating oil circuit 27 ensures an adequate supply of the lubricating points (not shown). The free jet centrifuge 10 is arranged in the bypass to an oil filter 32. A control valve 33 is used to regulate the oil supply to the free jet centrifuge.

The various measuring signals can be stored as characteristics in engine control unit 29. They make it possible to evaluate the flawless functioning of the free jet centrifuge. In addition, the relationships between the individual measuring signals can be stored in the control unit. An example of a relationship which can be stored in the control unit is the relationship between acceleration time and rotor loading (i.e., accumulation of sediment in the rotor). This provides a specific ratio of z to f. By electronically comparing a measured acceleration time against the stored relationship data, the degree of loading of the centrifuge rotor can be determined.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations falling within the scope of the appended claims and equivalents thereof.

What is claimed is:

1. A method of monitoring a free jet centrifuge comprising a rotor with at least one drive nozzle through which a liquid to be centrifuged is discharged to drive the rotor about an axis of rotation, said method comprising monitoring at least one rotor parameter independently of any axial force produced by the discharge of liquid through the at least one drive nozzle and acting in the direction of the axis of rotation.

2. A method according to claim 1, wherein said centrifuge is an oil centrifuge arranged in a lubricating oil circuit of an internal combustion engine.

3. A method according to claim 1, wherein said monitoring comprises processing a signal from a pressure sensor to determine an axial force acting on the rotor independent of the operating state of the centrifuge.

4. A method according to claim 3, wherein said pressure sensor is a piezoelectric sensor.

5. A method according to claim 1, wherein said monitoring comprises processing a signal from a rotational speed sensor to determine the rotational speed of the rotor.

6. A method according to claim 5, wherein said rotational speed sensor is an optoelectronic sensor.

7. A method according to claim 1, wherein said monitoring comprises measuring the time required for the rotor to transition between two characteristic operating states, and wherein the characteristic operating states are determined by additional sensors.

8. A method according to claim 1, wherein said monitoring is carried out by at least one sensor having at least one additional function outside the centrifuge being monitored.

9. A method according to claim 1, wherein measured values determined by said monitoring are additionally used to monitor viscosity of the liquid to be centrifuged.

10. A free jet centrifuge comprising:
a housing, and
a rotor having at least one drive nozzle and rotatably supported in said housing;
wherein said rotor is axially fixed in at least one direction, and wherein a pressure sensor is provided for measuring axial forces acting on the axially fixed rotor.

11. A free jet centrifuge according to claim 10, wherein said pressure sensor is a piezoelectric sensor.

12. A free jet centrifuge according to claim 10, wherein said pressure sensor measures axial forces independently of any axial force produced by discharge of liquid through the at least one drive nozzle.

13. A free jet centrifuge according to claim 10, wherein the rotor is supported without any axial play in said housing.

14. A free jet centrifuge according to claim 13, wherein the rotor is supported in the housing by a ball bearing.

15. A free jet centrifuge according to claim 10, further comprising an electronic evaluation unit connected to said pressure sensor.

16. A free jet centrifuge comprising:
a housing;
a rotor rotatably supported in said housing, said rotor having at least one drive nozzle through which a liquid to be centrifuged is discharged to drive the rotor about an axis of rotation, and being axially fixed in at least one direction; and
a speed sensor for determining the rotational speed of said rotor.

17. A free jet centrifuge according to claim 16, wherein said speed sensor is an optoelectronic sensor.

18. A free jet centrifuge according to claim 16, further comprising an electronic evaluation unit connected to said speed sensor.
